(19) United States
(12) Patent Application Publication
(10) Pub. No.: US 2018/0293915 A1
(43) Pub. Date: Oct. 11, 2018

(54) SYNCHRONIZING SOFTWARE MODULES

(71) Applicant: The Board Of Regents Of The Nevada System Of Higher Education On Behalf Of The University Of Ne, Las Vegas, NV (US)

(72) Inventors: Alexander Paz-Cruz, Henderson, NV (US); John Bertini, Las Vegas, NV (US); Justin Baker, Las Vegas, NV (US)

(21) Appl. No.: 15/768,761

(22) PCT Filed: Oct. 14, 2016
(86) PCT No.: PCT/US16/57144

§ 371 Date: Apr. 16, 2018

Related U.S. Application Data
(60) Provisional application No. 62/242,085, filed on Oct. 15, 2015.

(51) Int. Cl. G09B 29/00

(52) U.S. Cl. CPC G09B 29/007

(57) ABSTRACT

Provided are methods and systems comprising a geographical mapping module; a data analytic module; and an integrator module, wherein the integrator module causes data changes input into the geographical mapping module to be reflected in the data analytic module, and wherein the integrator module causes data changes input into the data analytic module to be reflected in the geographical mapping module.

### CROSS REFERENCE TO RELATED PATENT APPLICATION

This application claims priority to U.S. Provisional Application No. 62/242,085 filed Oct. 15, 2015, herein incorporated by reference in its entirety.

### SUMMARY

It is to be understood that both the following general description and the following detailed description are exemplary and explanatory only and are not restrictive. Provided are methods and systems comprising a geographical mapping module; a data analytic module; and an integrator module, wherein the integrator module causes data changes input into the geographical mapping module to be reflected in the data analytic module, and wherein the integrator module causes data changes input into the data analytic module to be reflected in the geographical mapping module.

Provided herein are methods and systems for accessing a first server, wherein the first server comprises a geographical mapping module, wherein accessing the first server causes a second server to be accessed, and wherein the second server comprises a data analytic module; updating data associated with the first server; and synchronizing data associated with the second server with the updated data associated with the first server.

Provided herein are methods and systems for receiving a request for a dashboard associated with a geographical mapping module; accessing a first server, wherein the first server comprises a data analytic module; receiving data from the first server; accessing a second server, wherein the second server comprises the geographical mapping module; and receiving data from the second server.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and, together with the description, serve to explain the principles of the methods and systems:

FIG. 1 is a block diagram of an exemplary system and network;

FIG. 2 is a block diagram of an exemplary system and network;

FIG. 3 is a sequence diagram of an exemplary method;

FIG. 4 is a sequence diagram of an exemplary method;

FIG. 5 is a flow chart of an exemplary method;

FIG. 6 is a flow chart of an exemplary method;

FIG. 7 is a block diagram of an exemplary computing device;

FIG. 8 is a user interface used in an exemplary method;

FIG. 9 is a user interface used in an exemplary method;

FIG. 10 is a user interface used in an exemplary method;

FIG. 11 is a user interface used in an exemplary method;

FIG. 12 is a user interface used in an exemplary method; and

FIG. 13 is a user interface used in an exemplary method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that, while specific reference of each various individual and collective combinations and permutation of these may not be explicitly disclosed, each is specifically contemplated and described herein for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

In an aspect, a first computing device can comprise a data analytic module. In an aspect, the data analytic module can comprise business intelligence instructions (such as Oracle Business Intelligence Enterprise Edition). In an aspect, the data analytic module can comprise dimensional modeling. In an aspect, the data analytic module can be web-based. In a further aspect, the data analytic module can be accessed via a web browser. In an aspect, the first computing device and/or a second computing device can comprise a geographical mapping module. In an aspect, the geographical mapping module can comprise a geographic information system (GIS) program (such as ArcGIS Server by Esri). In an aspect, the geographical mapping module can comprise a geospatial processing program (such as ArcMap by Esri). In an aspect, the geographical mapping module can be web-based. In a further aspect, the geographical mapping module can be accessed via a web browser.

In an aspect, a geographical mapping module can be integrated with a data analytic module. In an aspect, data manipulated with the geographical mapping module can be exported (e.g., outputted, transmitted, etc.) to the integrator module. In an aspect, the integrator module can parse (e.g., extract, interpret, etc.) the exported manipulated data. In an aspect, the integrator module can reformat (e.g., condition, prepare) the parsed manipulated data for input into the data analytic module, such that the data in the geographical mapping module is synchronized with the data in the data analytic module. In an aspect, data manipulated with the data analytic module can be exported (e.g., outputted, transmitted, etc.) to the integrator module. In an aspect, the integrator module can parse (e.g., extract, interpret, etc.) the exported manipulated data. In an aspect, the integrator module can reformat (e.g., condition, prepare) the parsed manipulated data for input into the geographical mapping module, such that the data in the data analytic module is synchronized with the data in the geographic mapping module. In an aspect, the integrator module can be web-based. In a further aspect, the integrator module can be accessed via a web browser. In an aspect, the geographical mapping module can be used for geometry. In an aspect, the geometry can be changed based on data from the data analytical module. In an aspect, data retrieved from the data analytical module can be presented with a map generated from the geographical mapping module. In an aspect, the data retrieved from the data analytical module can be synchronized with the map generated from the geographical mapping module.

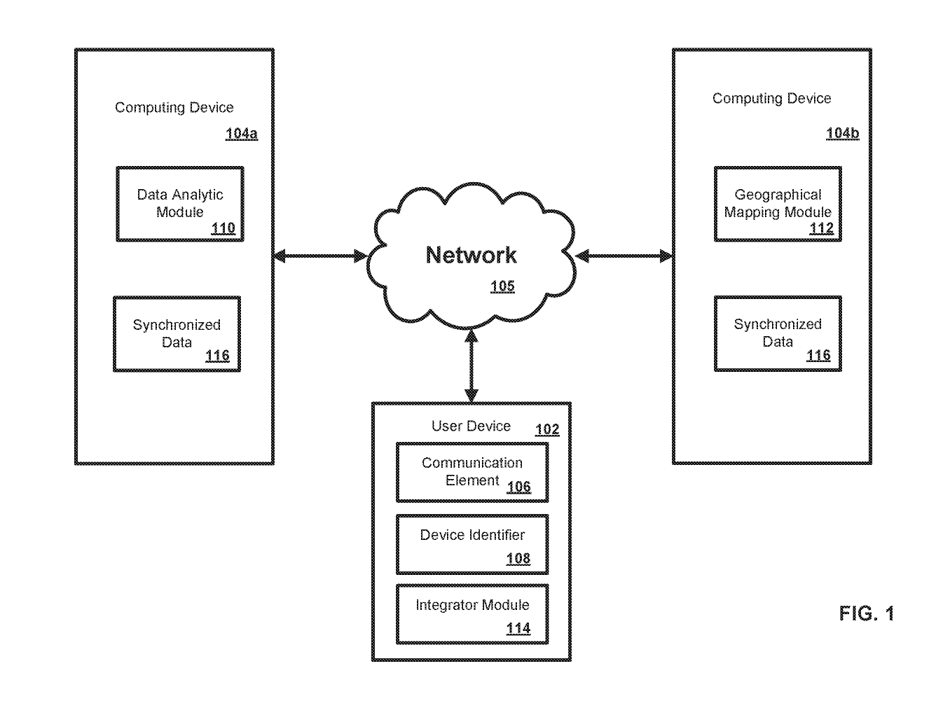

FIG. 1 illustrates various aspects of an exemplary environment in which the present methods and systems can operate. The network and system can comprise a user device 102 in communication with one or more computing devices 104a, 104b such as one or more servers, for example. The one or more computing devices 104a, 104b can be disposed locally or remotely relative to the user device 102. As an example, the user device 102 and the one or more computing devices 104a, 104b can be in communication via a private and/or public network 105 such as the Internet or a local area network. Other forms of communications can be used such as wired and wireless telecommunication channels, for example.

In an aspect, the user device 102 can be an electronic device such as a computer, a smartphone, a laptop, a tablet, a set top box, a display device, or other device capable of communicating with the one or more computing devices 104a, 104b. As an example, the user device 102 can comprise a communication element 106 for providing an interface to a user to interact with the user device 102 and/or the one or more computing devices 104a, 104b. The communication element 106 can be any interface for presenting and/or receiving information to/from the user, such as user feedback. An example interface may be communication interface such as a web browser (e.g., Internet Explorer, Mozilla Firefox, Google Chrome, Safari, or the like). Other software, hardware, and/or interfaces can be used to provide communication between the user and one or more of the user device 102 and the one or more computing devices 104a, 104b. As an example, the communication element 106 can request or query various files from a local source and/or a remote source. As a further example, the communication element 106 can transmit data to a local or remote device such as the one or more computing devices 104a, 104b.

In an aspect, the user device 102 can be associated with a user identifier or device identifier 108. As an example, the device identifier 108 can be any identifier, token, character, string, or the like, for differentiating one user or user device (e.g., user device 102) from another user or user device. In a further aspect, the device identifier 108 can identify a user or user device as belonging to a particular class of users or user devices. As a further example, the device identifier 108 can comprise information relating to the user device such as a manufacturer, a model or type of device, a service provider associated with the user device 102, a state of the user device 102, a locator, and/or a label or classifier. Other information can be represented by the device identifier 108.

In an aspect, a first computing device 104a can comprise a data analytic module 110. In an aspect, the data analytic module 110 can comprise business intelligence instructions (such as Oracle Business Intelligence Enterprise Edition). In an aspect, the data analytic module 110 can comprise dimensional modeling and descriptive statistics as well as advanced analytics such as data mining, forecasting, and special purpose algorithms and calculations. In an aspect, the data analytic module can comprise OLAP databases (such as Oracle's Essbase) and spreadsheets (such as Microsoft's Excel). In an aspect, the data analytic module can comprise comma-separated values or text file data connected to a business intelligence or database program. In an aspect, a second computing device 104b can comprise a geographical mapping module 112. In an aspect, the geographical mapping module 112 can comprise a geographic information system (GIS) program (such as ArcGIS Server by Esri). In an aspect, the geographical mapping module 112 can comprise a geospatial processing program (such as ArcMap by Esri).

In an aspect, the user device 102 can comprise an integrator module 114. In an aspect, the integrator module 114 can synchronize data between the data analytic module 110 and the geographical mapping module 112. In an aspect, the integrator module 114 can cause data changes input into the geographical mapping module 112 to be reflected in the data analytic module 110. In an aspect, the integrator module 114 can cause data changes input into the data analytic module 110 to be reflected in the geographical mapping module 112. In an aspect, after changes are made to either the data analytic module 110 or the geographical mapping module 112, the integrator module 114 can cause the data reflecting the changes to be exported. In an aspect, after changes are made to either the data analytic module 110 or the geographical mapping module 112, the integrator module 114 can receive the data reflecting the changes as output. In a further aspect, the integrator module 114 can parse output from the data analytic module 110. In an aspect, the integrator module 114 can reformat the parsed output from the data analytic module 110 as input for the geographical mapping module 112. In an aspect, inputting the reformatted input into the geographical mapping module 112 can synchronize data 116 between the first computing device 104a and the second computing device 104b. In another further aspect, the integrator module 114 can parse output from the geographical mapping module 112. In an aspect, the integrator module 114 can reformat the parsed output from the geographical mapping module 112 as input for the data analytic module 110. In an aspect, inputting the reformatted input into the data analytic module 110 can synchronize data 116 between the first computing device 104a and the second computing device 104b.

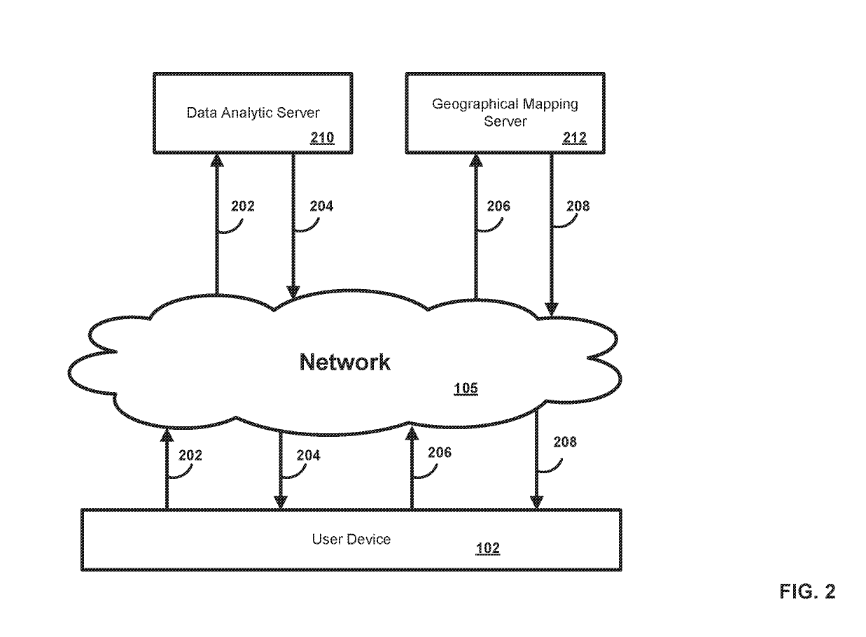

Turning now to FIG. 2, the user device 102 can communicate with a data analytic server 210 and a geographical mapping server 212. In an aspect, the user device 102 can communicate with the data analytic server 210 and the geographical mapping server 212 via a network 105. In an aspect, the user device 102 can make a request 202 for a dashboard (e.g., user interface, etc.) to the data analytic server 210. In an aspect, the data analytic server 210 can respond 204 by returning the dashboard to the user device 102, wherein the returned dashboard comprises embedded instructions (e.g., code, commands, etc.). In an aspect, when the returned dashboard is run on the user device 102, the user device 102 can request 206 information from the geographical mapping server 212. In an aspect, the geographical mapping server 212 can respond 208 by returning the requested information to the user device 102.

In another aspect, the user device 102 can make a request 206 for a dashboard (e.g., user interface, etc.) to the geographical mapping server 212. In an aspect, the geographical mapping server 212 can respond 208 by returning the dashboard to the user device 102, wherein the returned dashboard comprises embedded instructions (e.g., code, commands, etc.). In an aspect, when the returned dashboard is run on the user device 102, the user device 102 can be caused to request 202 information from the data analytic server 210. In an aspect, the data analytic server 210 can respond 204 by returning the requested information to the user device 102.

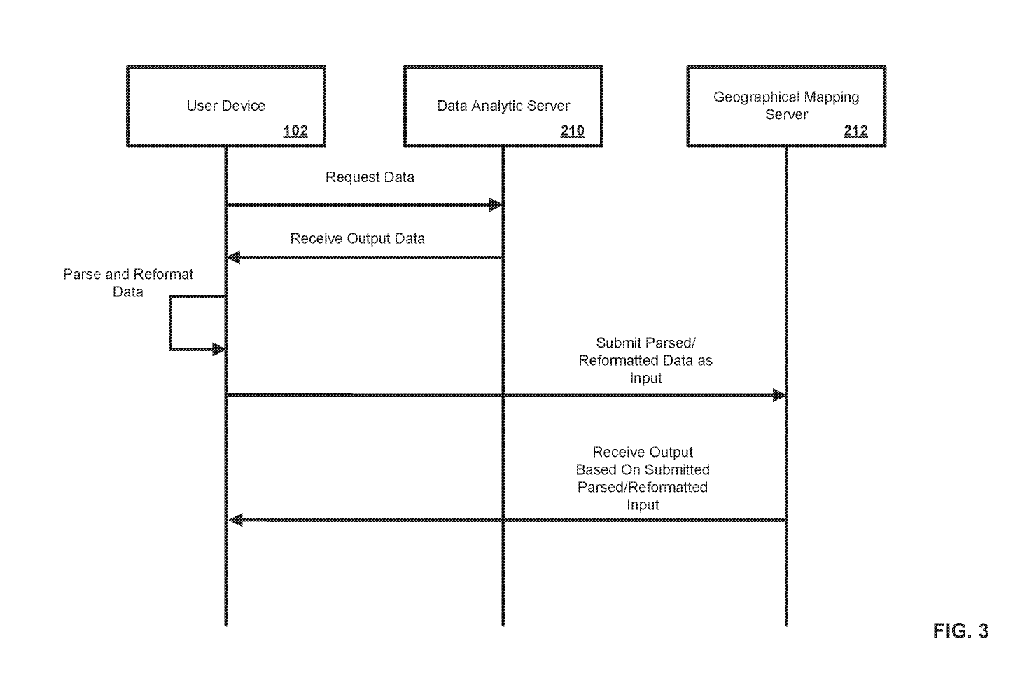

Turning now to FIG. 3, a sequence diagram of an exemplary method is illustrated. At a first time, the user device 102 can request data from the data analytic server 210. At a second time, the user device 102 can receive output data from the data analytic server 210. At a third time, the user device 102 can parse the received output. In an aspect, the user device 102 can reformat the data in a manner acceptable as input by the geographical mapping server 212. At a fourth time, the user device 102 can submit the reformatted data as input to a module (e.g., program, etc.) running (e.g., operating, executing, etc.) on the geographical mapping server 212. At a fifth time, the user device 102 can receive output from the geographical mapping server 212 based on the submitted input.

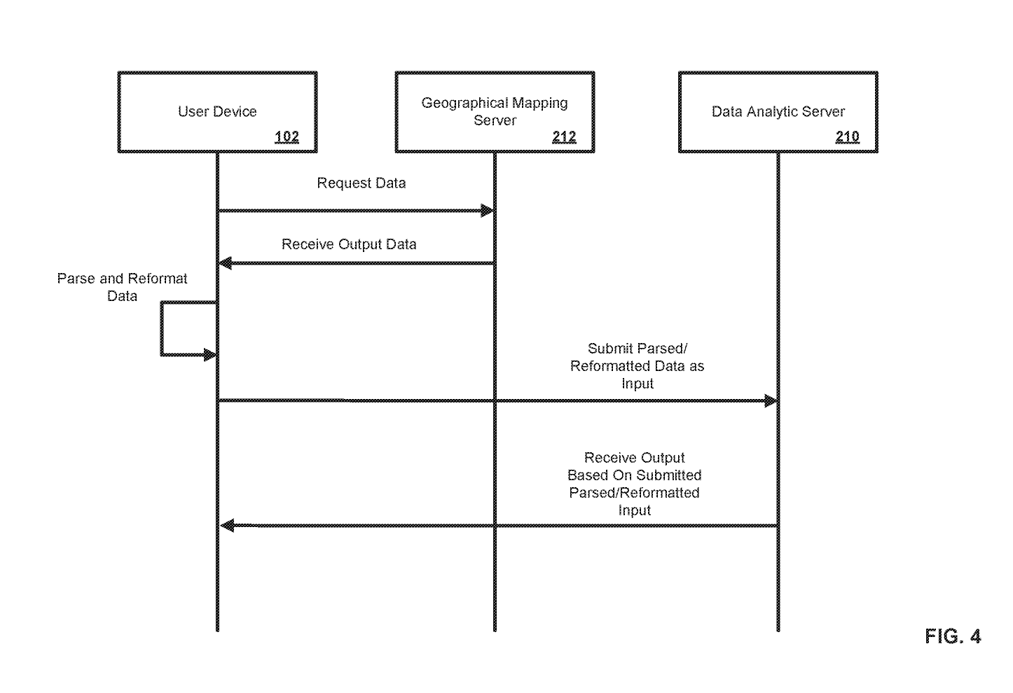

Turning now to FIG. 4, a sequence diagram of an exemplary method is illustrated. At a first time, the user device 102 can request data from the geographical mapping server 212. At a second time, the user device 102 can receive output data from the geographical mapping server 212. At a third time, the user device 102 can parse the received output. In an aspect, the user device 102 can reformat the data in a manner acceptable as input by the data analytic server 210. At a fourth time, the user device 102 can submit the reformatted data as input to a module (e.g., program, etc.) running (e.g., operating, executing, etc.) on the data analytic server 210. At a fifth time, the user device 102 can receive output from the data analytic server 210 based on the submitted input.

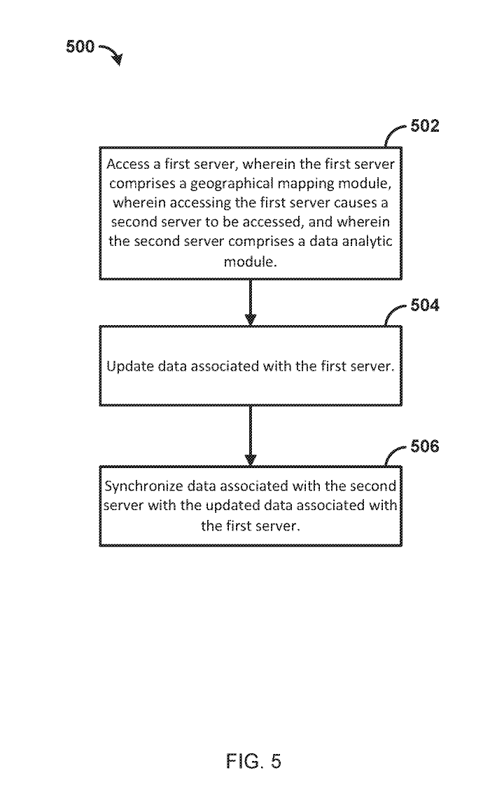

Turning now to FIG. 5, a flowchart 500 of an exemplary method is illustrated. At step 502, a first server can be accessed. In a further aspect, accessing the first server can comprise querying the first server. In an aspect, the first server can comprise a geographical mapping module. In an aspect, accessing the first server can cause a second server to be accessed. In an aspect, the second server can comprise a data analytic module. At step 504, data associated with the first server can be updated. In an aspect, the data associated with the first server can comprise spatial data. In an aspect, the data associated with the first server can comprise data for geographical modeling and any kind of data involving geometry. At step 506, data associated with the second server can be synchronized with the updated data associated with the first server. In an aspect, the data associated with the second server can comprise any relational data. In an aspect, the data associated with the second server can comprise statistical data. In an aspect, the data associated with the second server can comprise data for statistical modeling. In an aspect, the data associated with the second server can comprise data from an online analytical processing (OLAP) cube database (such as Oracle's Essbase). In an aspect, the data associated with the second server can comprise data taken from a spreadsheet (such as Microsoft's Excel). In an aspect, the data associated with the second server can comprise data taken from a comma separated value (CSV) file or test file.

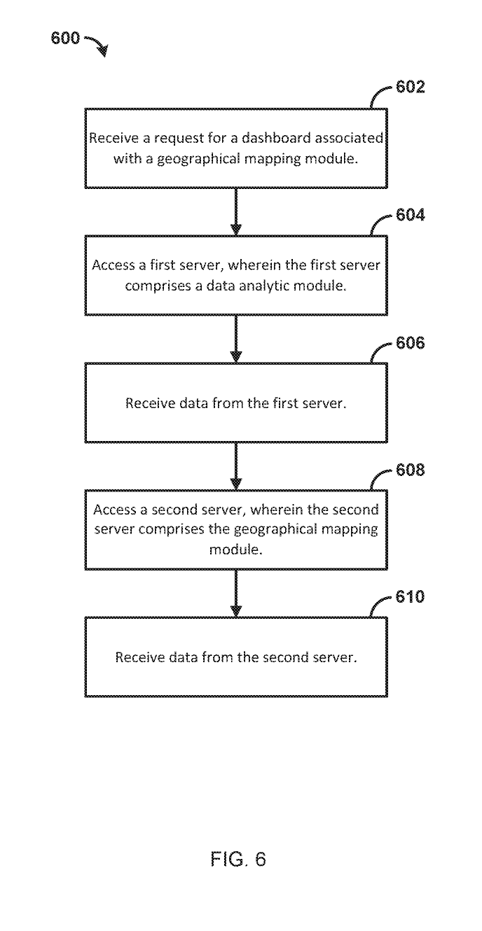

Turning now to FIG. 6, a flowchart 600 of an exemplary method is illustrated. At step 602, a request for a dashboard associated with a geographical mapping module can be received. In an aspect, the dashboard can comprise shortcuts for one or more applications (e.g., functions, procedures, etc.). At step 604, a first server can be accessed. In an aspect, the first server can comprise a data analytic module. At step 606, data can be received from the first server. In an aspect, the data received from the first server can comprise spatial data. In an aspect, the data received from the first server can comprise data for geographical modeling. In an aspect, the data received from the first server can comprise any kind of data involving geometry. At step 608, a second server can be accessed. In an aspect, the second server can comprise the geographical mapping module. In an aspect, the second server can be accessed in response to instructions (e.g., code, commands, etc.) originating with (e.g., embedded in, etc.) the data received from the first server. In an aspect, the instructions can be in JavaScript. At step 610, data can be received from the second server. In an aspect, the data received from the second server can comprise statistical data. In an aspect, the data received from the second server can comprise data for statistical modeling. In an aspect, the data associated with the second server can comprise any relational data. In an aspect, the data associated with the second server can comprise data from an OLAP cube database (such as Oracle's Essbase). In an aspect, the data associated with the second server can comprise data taken from a spreadsheet (such as Microsoft's Excel). In an aspect, the data associated with the second server can comprise data taken from a comma separated value (CSV) file or test file.

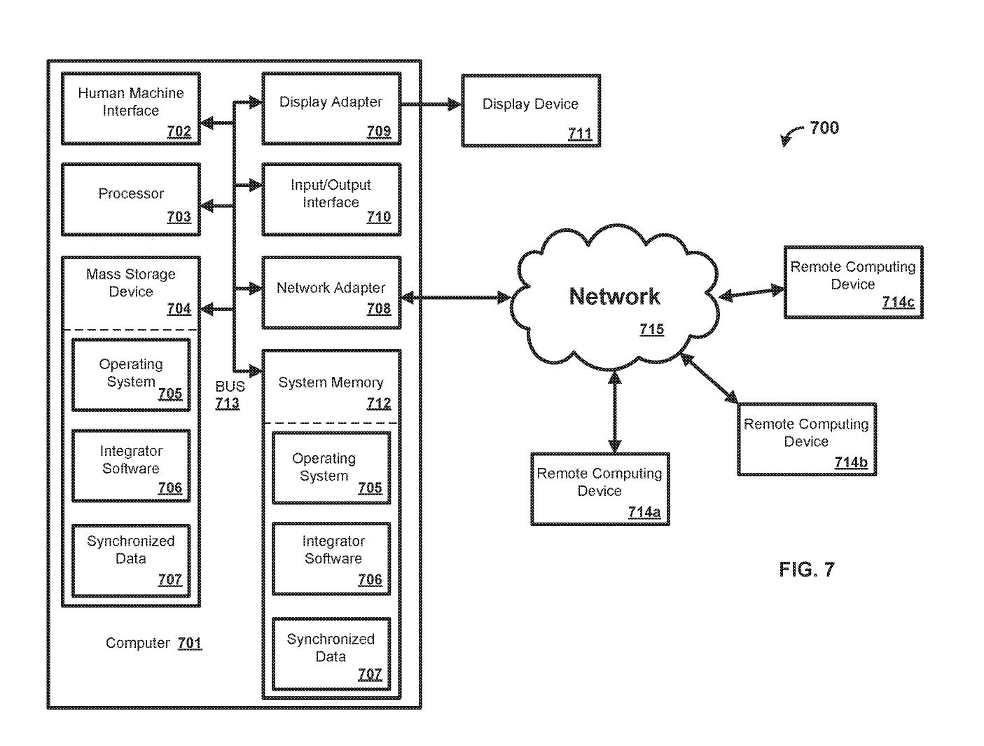

In an exemplary aspect, the methods and systems can be implemented on a computer 701 as illustrated in FIG. 7 and described below. By way of example, the computing devices 104a,b of FIG. 1 can be computers as illustrated in FIG. 7. Similarly, the methods and systems disclosed can utilize one or more computers to perform one or more functions in one or more locations. FIG. 7 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 701. The components of the computer 701 can comprise, but are not limited to, one or more processors 703, a system memory 712, and a system bus 713 that couples various system components including the one or more processors 703 to the system memory 712. The system can utilize parallel computing.

The system bus 713 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), a Universal Serial Bus (USB) and the like. The bus 713, and all buses specified in this description can also be implemented over a wired or wireless network connection and each of the subsystems, including the one or more processors 703, a mass storage device 704, an operating system 705, integrator software 706, synchronized data 707, a network adapter 708, the system memory 712, an Input/Output Interface 710, a display adapter 709, a display device 711, and a human machine interface 702, can be contained within one or more remote computing devices 714a,b,c at physically separate locations, connected through buses of this form, in effect implementing a fully distributed system.

The computer 701 typically comprises a variety of computer readable media. Exemplary readable media can be any available media that is accessible by the computer 701 and comprises, for example and not meant to be limiting, both volatile and non-volatile media, removable and non-removable media. The system memory 712 comprises computer readable media in the form of volatile memory, such as random access memory (RAM), and/or non-volatile memory, such as read only memory (ROM). The system memory 712 typically contains data such as the synchronized data 707 and/or program modules such as the operating system 705 and the integrator software 706 that are immediately accessible to and/or are presently operated on by the one or more processors 703.

In another aspect, the computer 701 can also comprise other removable/non-removable, volatile/non-volatile computer storage media. By way of example, FIG. 7 illustrates the mass storage device 704 which can provide non-volatile storage of computer code, computer readable instructions, data structures, program modules, and other data for the computer 701. For example and not meant to be limiting, the mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, the operating system 705 and the integrator software 706. Each of the operating system 705 and the integrator software 706 (or some combination thereof) can comprise elements of the programming and the integrator software 706. The synchronized data 707 can also be stored on the mass storage device 704. The synchronized data 707 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 701 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 703 via the human machine interface 702 that is coupled to the system bus 713, but can be connected by other interface and bus structures, such as a parallel port, game port, an IEEE 1394 Port (also known as a Firewire port), a serial port, or a universal serial bus (USB).

In yet another aspect, the display device 711 can also be connected to the system bus 713 via an interface, such as the display adapter 709. It is contemplated that the computer 701 can have more than one display adapter 709 and the computer 701 can have more than one display device 711. For example, the display device 711 can be a monitor, an LCD (Liquid Crystal Display), or a projector. In addition to the display device 711, other output peripheral devices can comprise components such as speakers (not shown) and a printer (not shown) which can be connected to the computer 701 via the Input/Output Interface 710. Any step and/or result of the methods can be output in any form to an output device. Such output can be any form of visual representation, including, but not limited to, textual, graphical, animation, audio, tactile, and the like. The display device 711 and computer 701 can be part of one device, or separate devices.

The computer 701 can operate in a networked environment using logical connections to one or more remote computing devices 714a,b,c. By way of example, a remote computing device can be a personal computer, portable computer, smartphone, a server, a router, a network computer, a peer device or other common network node, and so on. Logical connections between the computer 701 and a remote computing device 714a,b,c can be made via a network 715, such as a local area network (LAN) and/or a general wide area network (WAN). Such network connections can be through the network adapter 708. The network adapter 708 can be implemented in both wired and wireless environments. Such networking environments are conventional and commonplace in dwellings, offices, enterprise-wide computer networks, intranets, and the Internet.

For purposes of illustration, application programs and other executable program components such as the operating system 705 are illustrated herein as discrete blocks, although it is recognized that such programs and components reside at various times in different storage components of the computing device 701, and are executed by the one or more processors 703 of the computer. An implementation of the integrator software 706 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

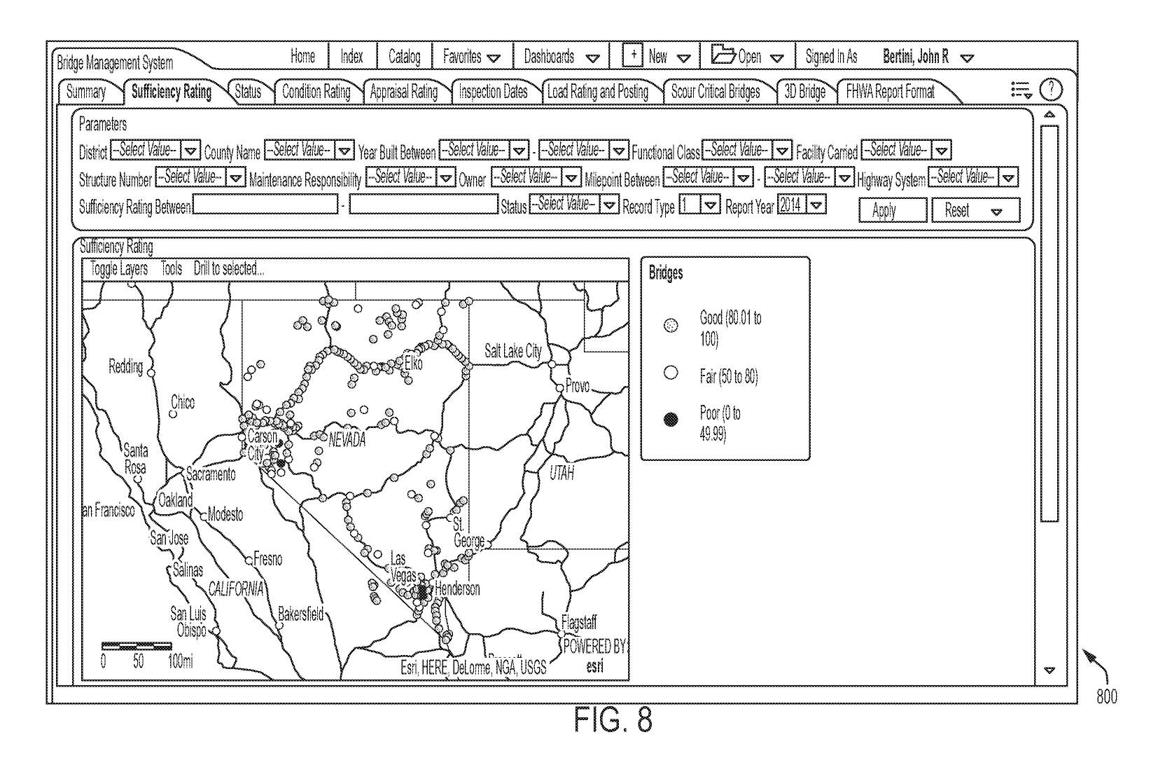

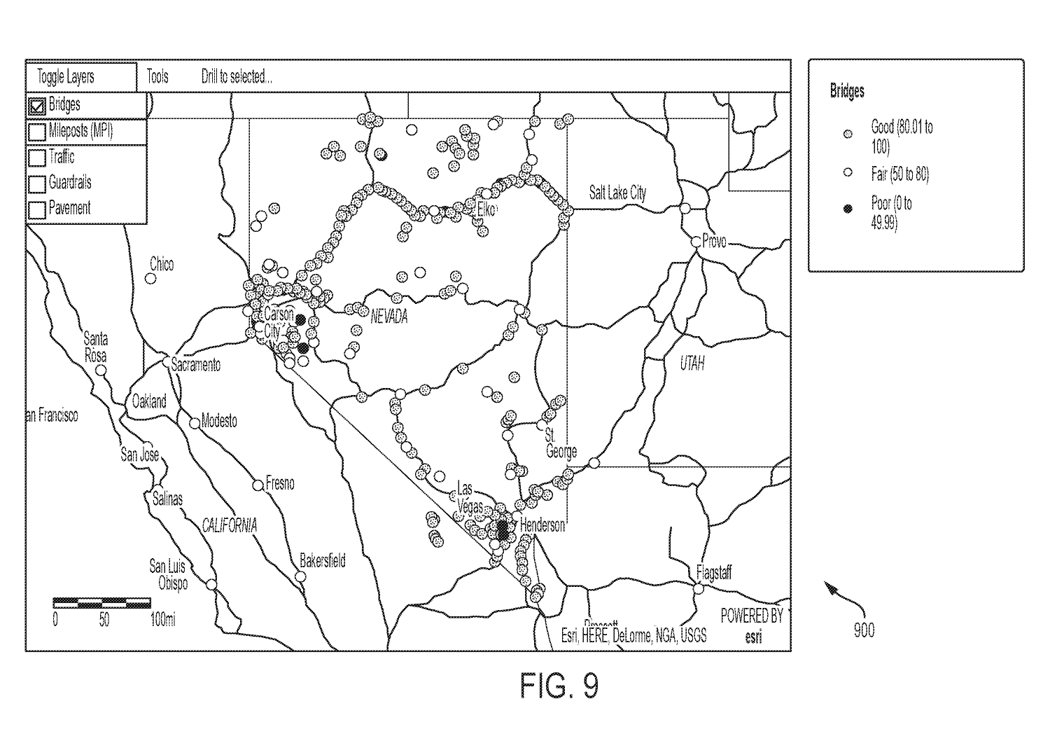

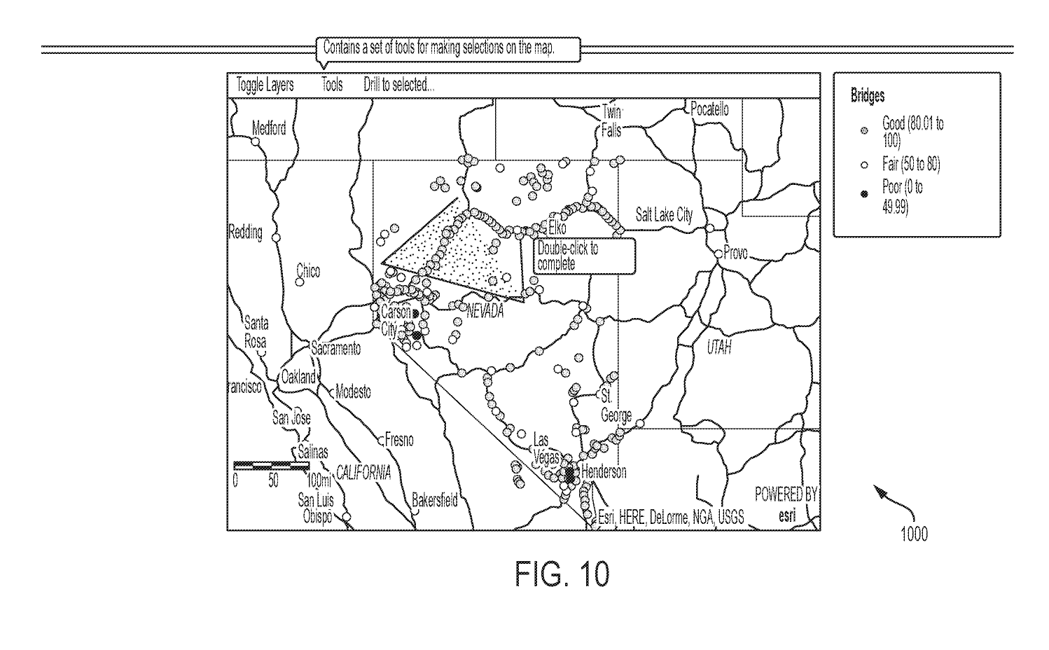

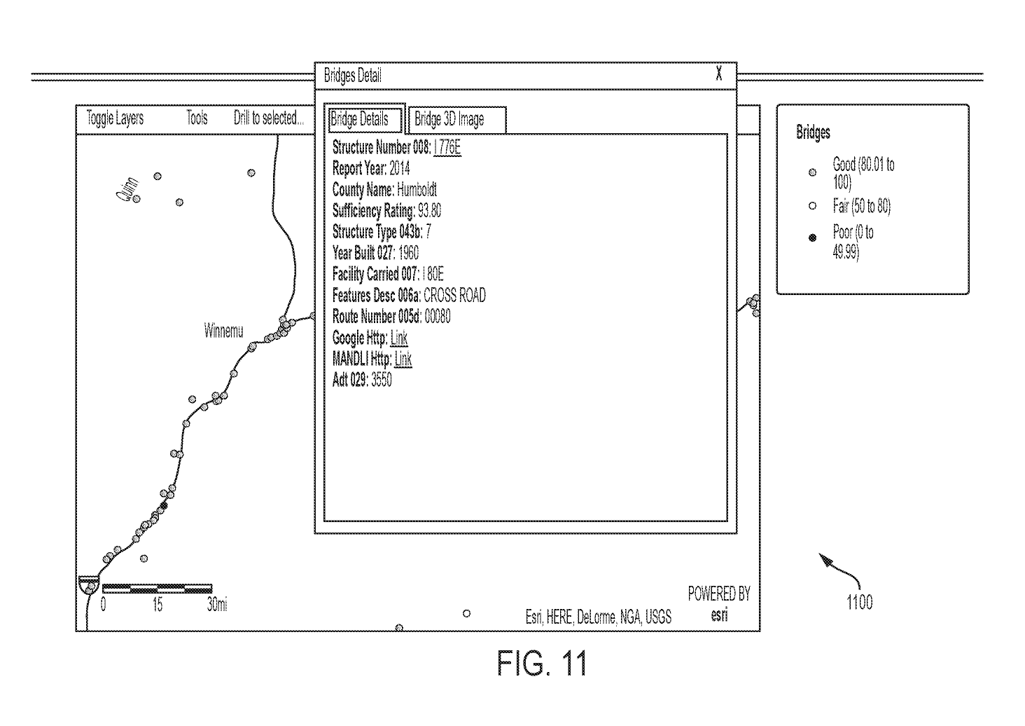

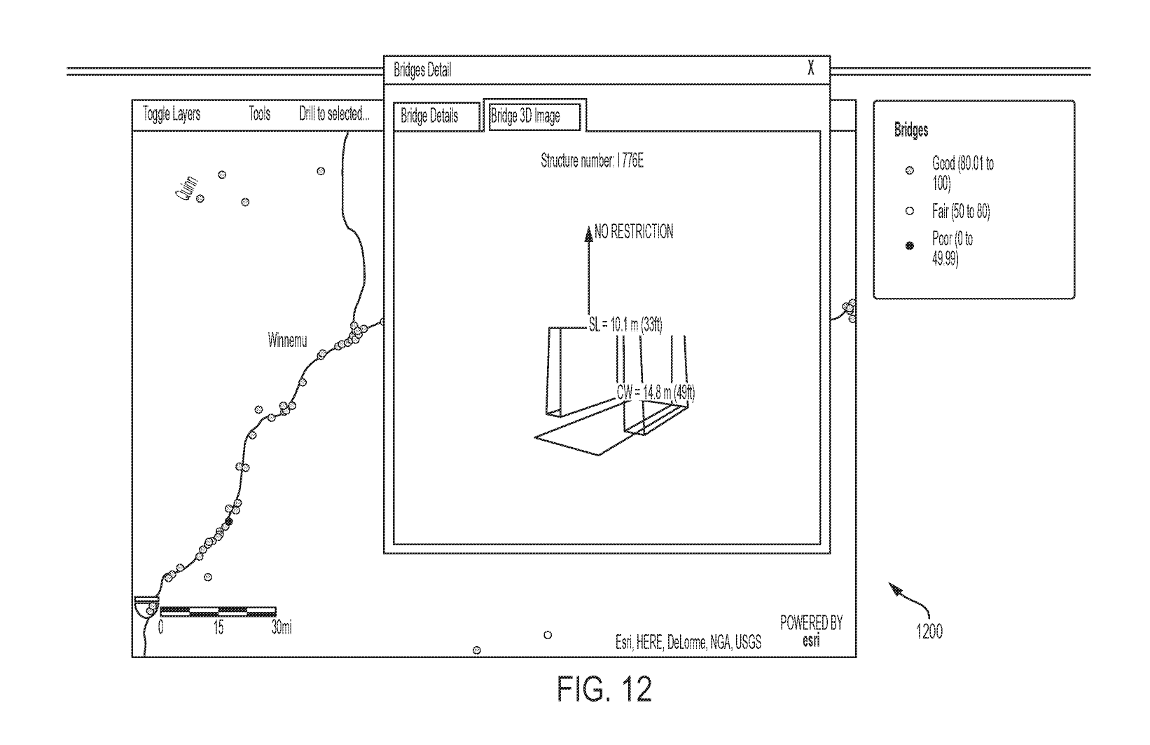

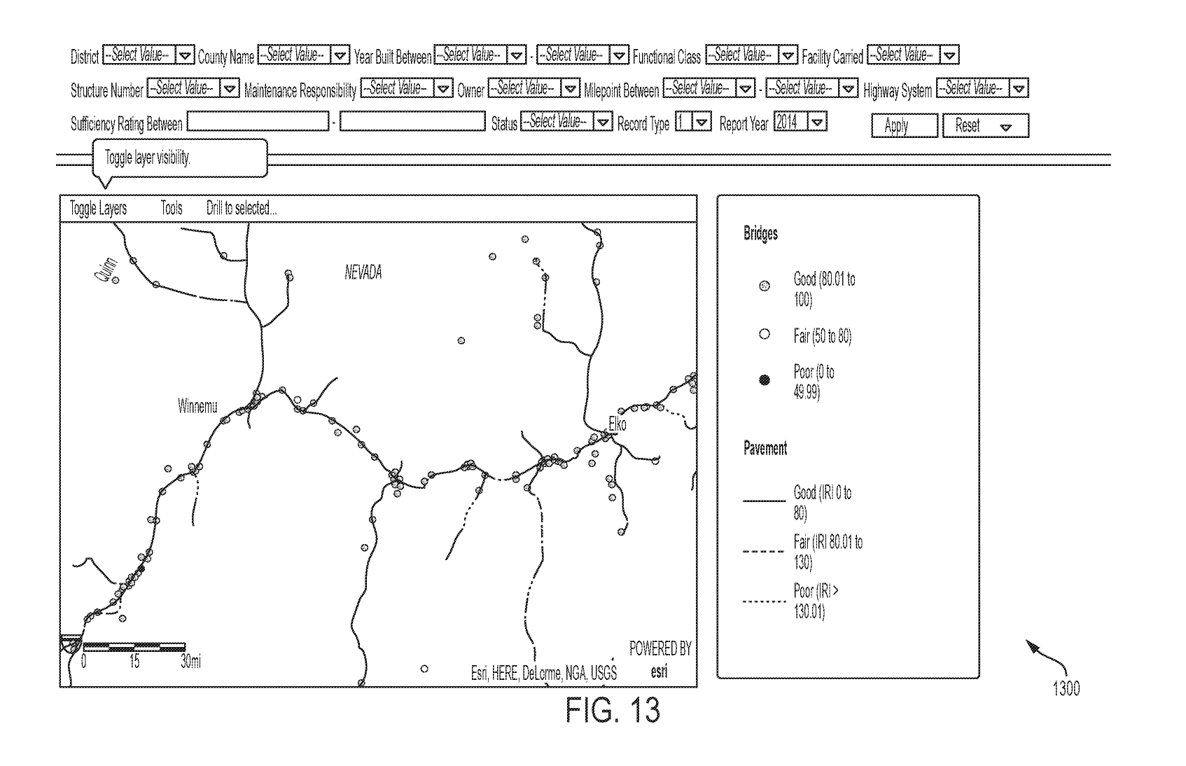

Turning now to FIGS. 8-13, user interfaces 800-1300 used with an exemplary method are illustrated. In an aspect, the user interfaces 800-1300 can comprise a map generated using the geographical mapping module. In an aspect, responsive to an event, the user interfaces 800-1300 can comprise data retrieved using the data analytic module. In an aspect, the user interfaces 800-1300 can display data retrieved using the data analytic module in response to an event related to the map generated using the geographical mapping module. For example, the event can comprise a click, a roll over, or some other engagement with an object comprised by the map. In an aspect, the user interfaces 800-1300 can comprise one or more layers. Each layer can comprise a unique set of geometry supplied by a geographical information system (GIS) server. Each layer can comprise one or more specific pop-up windows, comprising information pertaining to the layer. Each layer can direct a user to one or more URL location comprising further information about a specific selected set of geometry. In an aspect, in response to clicking an area of the map on the user interfaces 800-1300, the user interfaces 800-1300 can be refreshed with the selected area generated by the geographical mapping module and with corresponding refreshed data retrieved by the data analytic module.

In an aspect, a configuration file can be used to change the color scheme of the user interfaces 800-1300. In an aspect, the configuration file can be created using a web-based tool. In an aspect, the configuration file can be auto-populated. In an aspect, auto-population can occur via requests to the geographical information system (GIS) server specified by a user. In an aspect, auto-population can occur via requests to the data analytical module. In an aspect, the configuration file can cause a map to be generated using the geographical mapping module with data retrieved from the data analytical module. In an aspect, the configuration file can define the map layers that appear in an instance of a map. In an aspect, the configuration file can define the color and appearance of symbols drawn on the map. In an aspect, the configuration file can define rules that change the color or symbol of a piece of map geometry based upon a set of pre-defined breakpoints. Data for each piece of geometry can be checked against the rules, and an appropriate symbol can be selected for each individual geometry object. In an aspect, the configuration file can define the behavior and contents of a pop-up window that appears when each piece of geometry is clicked. The contents can comprise images, data taken from a database, and other associated information. In an aspect, the configuration file can define user control over layer visibility. In an aspect, the configuration file can specify data shared between the geographical mapping module and the data analytical module, allowing for more efficient synchronization via column-limited queries. In an aspect, the configuration file can control whether a map layer is visible by default. In an aspect, the configuration file can define the channel by which data is passed from the data analytical module to the map. In an aspect, a preview map can be generated as information is entered into the configuration file. In a further aspect, the preview map can be updated as information is updated in the configuration file. The preview map can receive user input and generate a preview map by accessing a specified geographical information system (GIS) server, retrieving geometry, and drawing the geometry using a symbol definition specified in the configuration file. The preview map can also allow users to test the pop-up windows specified in the configuration file to ensure that the information is displaying properly. The preview map can comprise the functionality of the final deployed map. In an aspect, a centralized configuration file can contain information specifying the relationship between map layers and their respective data sources. The centralized configuration file can store map layers that will appear in all maps for a specified installation. The common layers specified in the centralized configuration file can be overridden by individual map configuration files.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.16

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A system comprising:
a geographical mapping module;
a data analytic module; and
an integrator module, wherein the integrator module causes data changes input into the geographical mapping module to be reflected in the data analytic module, and wherein the integrator module causes data changes input into the data analytic module to be reflected in the geographical mapping module.

2. The system of claim 1, wherein the integrator module is configured to receive data as output from the geographical mapping module after a data change in input into the geographical mapping module.

3. The system of claim 2, wherein the integrator module is configured to parse the received data.

4. The system of claim 3, wherein the integrator module is configured to reformat the parsed data.

5. The system of claim 4, wherein the integrator module is configured to input the reformatted data into the data analytic module.

6. The system of claim 5, wherein the integrator module receives output from the data analytic module based on the inputted data.

7. The system of claim 6, wherein the integrator module displays the outputted data from the data analytic module.

8. The system of claim 1, wherein the integrator module is configured to receive data as output from the data analytical module after a data change in input into the data analytical module.

9. The system of claim 8, wherein the integrator module is configured to parse the received data.

10. The system of claim 9, wherein the integrator module is configured to reformat the parsed data.

11. The system of claim 10, wherein the integrator module is configured to input the reformatted data into the geographical mapping module.

12. The system of claim 11, wherein the integrator module receives output from the geographical mapping module based on the inputted data.

13. The system of claim 12, wherein the integrator module displays the outputted data from the geographical mapping module.

14. A method comprising:
accessing a first server, wherein the first server comprises a geographical mapping module, wherein accessing the first server causes a second server to be accessed, and wherein the second server comprises a data analytic module;
updating data associated with the first server; and
synchronizing data associated with the second server with the updated data associated with the first server.

15. The method of claim 14, wherein the geographical mapping module comprises a geographic information system (GIS) program.

16. The method of claim 14, wherein the geographical mapping module comprises a geospatial processing program.

17. The method of claim 14, wherein the data analytic module comprises business intelligence instructions.

18. The method of claim 14, wherein the data analytic module comprises dimensional modeling.

19. A method comprising:
receiving a request for a dashboard associated with a geographical mapping module;
accessing a first server, wherein the first server comprises a data analytic module;
receiving data from the first server;
accessing a second server, wherein the second server comprises the geographical mapping module; and
receiving data from the second server.

20. The method of claim 19, wherein the data analytic module comprises dimensional modeling.
